(19) United States
(12) Patent Application Publication
(10) Pub. No.: US 2009/0203389 A1
(43) Pub. Date: Aug. 13, 2009

(54) SYSTEMS AND METHODS FOR SYNCHRONIZING INFORMATION USING SHORT MESSAGE SERVICES AND EMAIL SERVICES

(75) Inventor: Satish Bhat, Edgewater, NJ (US)

Correspondence Address: K&L Gates LLP, P.O. Box 1135, CHICAGO, IL, 60690, US

(73) Assignee: SYNCPLANET LLC, Encino, CA (US)

(21) Appl. No.: 12/027,833

(22) Filed: Feb. 7, 2008

(51) Int. Cl. H04W 4/12; G06F 15/16

(52) U.S. Cl. 455/466; 709/206

(57) ABSTRACT

Methods and apparatus for synchronizing information via SMS and email services are disclosed. Devices are set to check locally for information updates and to receive information updates from other devices. When an information update occurs, a device prepares a message with the updated information and transmits the message to other devices within a group. Devices in the group receive a message with updated information and update information accordingly to synchronize information.

### TECHNICAL FIELD

The present application relates in general to exchanging information between devices and more specifically to systems and methods for synchronizing information using Short Message Services (“SMS”) and Email services.

### BACKGROUND

Mobile devices are becoming increasingly prevalent in the both the business and personal worlds. As mobile technology becomes more prevalent, the need for sharing information amongst large groups of mobile devices has increased. When sharing information within a large group, the group may want the information synchronized so that all group members may access information as required. With the increase in sharing information between mobile devices, many mobile device users may find it useful to synchronize all devices in a group, which may include mobile devices and non-mobile devices. Synchronizing these devices presents a challenge because many devices do not communicate on the same platforms, which impedes the information exchange required for synchronization. Users want their devices to seamlessly synchronize without spending time and effort synchronizing information between their own devices and/or other devices. Users want to share their information quickly and efficiently with a large group of other users in an unobtrusive manner.

Typically, synchronization is performed using a physical connection such as a USB cable or by using Hypertext Transfer Protocol (“HTTP”) via the internet. Using a USB cable requires both devices to be physically located in the same vicinity. When a user creates an appointment using their mobile device, the user may wish to make the information available to a large group of other users and may not be able to use a USB cable to synchronize the mobile device with all the other devices. Synchronization with HTTP also has drawbacks. Using HTTP to synchronize requires the use of an intermediate server to push information from one device to another. As the number of devices providing and receiving information updates increases, HTTP synchronization becomes increasingly inefficient and failure prone. HTTP fails to provide seamless synchronization for mobile and non-mobile devices.

### BRIEF DESCRIPTION OF THE FIGURES

FIG. 1 is a high level block diagram of an example network communicating system.

FIG. 2 is a detailed block diagram of an example network communicating system.

FIG. 3 is a block diagram of an example virtual community.

FIG. 4 is a flowchart of an example synchronization process.

FIG. 5 is a flowchart of an example SMS creation and transmission process.

FIG. 6 is a flowchart of an example SMS receiving and updating process.

FIG. 7 is a flowchart of an example email creation and transmission process.

FIG. 8 is a flowchart of an example email receiving and updating process.

FIG. 9 is an example screenshot showing a user interface for managing groups and contacts.

FIG. 10 is an example screenshot showing a user interface for managing contacts.

FIG. 11 is an example screenshot showing a user interface for managing groups.

### DETAILED DESCRIPTION OF EXAMPLE EMBODIMENTS

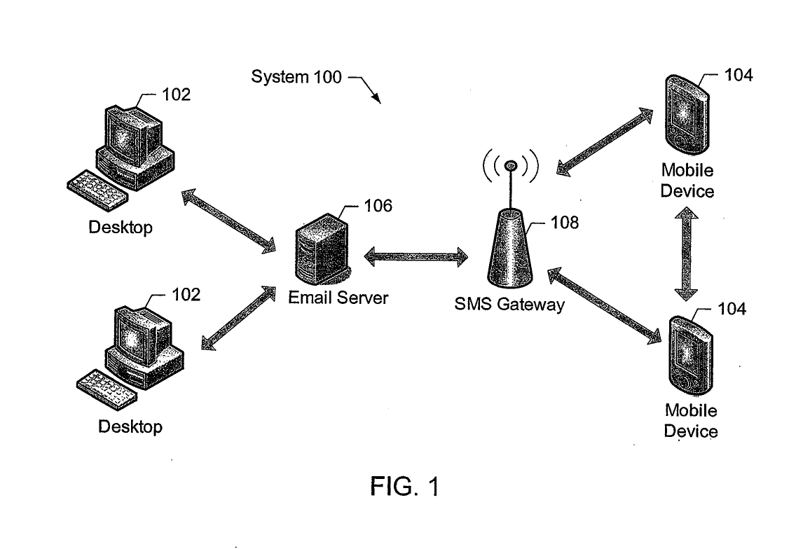

The present system is most readily realized in a network communications system. A high level block diagram of an example network communications system 100 is illustrated in FIG. 1. The illustrated system 100 includes one or more desktops 102 and one or more mobile devices 104. The desktops 102 may communicate with each other via an email server 106. The mobile devices 104 may communicate with each other via an SMS gateway 108. An SMS gateway 108 may be a mobile network carrier or a public gateway between networks. The desktops 102 may communicate with the mobile devices 104 via the email server 106 and the SMS gateway 108. The email server 106 and the SMS gateway 108 may communicate information on different platforms, which will be described in more detail below. It should be appreciated that any of the devices described herein may be configured to communicate with a network system other than an email server 106 and/or an SMS gateway 108. For example two desktops 102 may communicate via an instant messaging system rather than the illustrated email server 106.

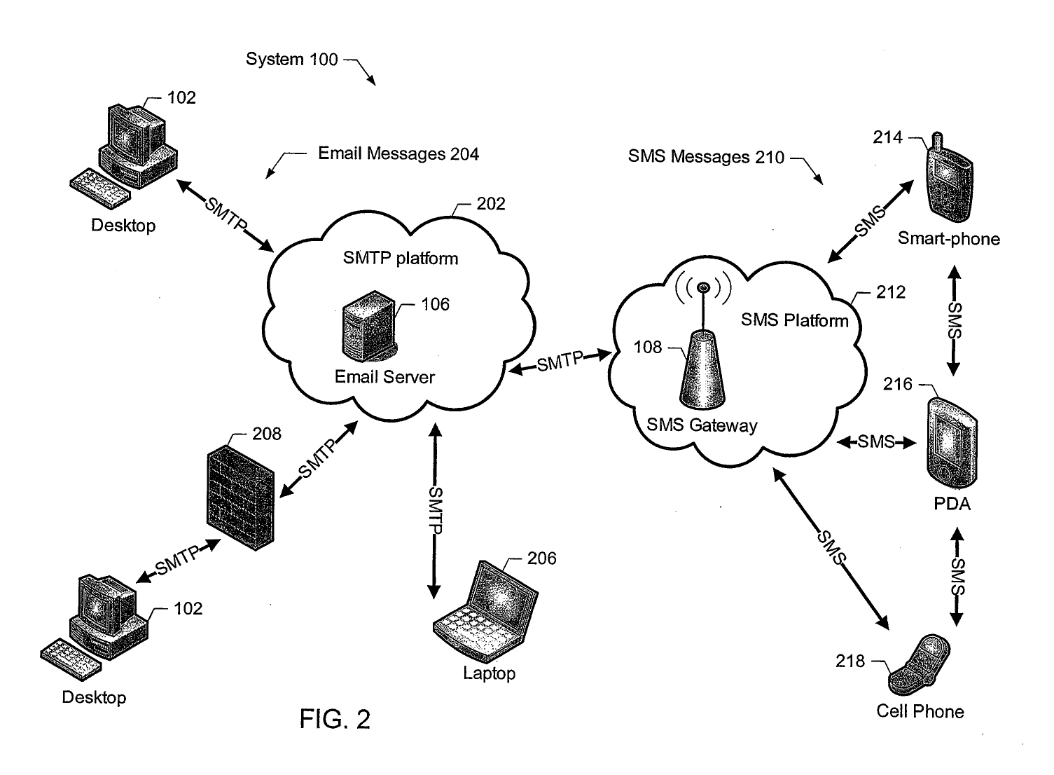

A detailed block diagram of an example network communications system 100 is illustrated in FIG. 2. In this example, a desktop 102 may communicate with other desktops 102 or mobile devices 104 via the SMTP platform 202. It should be appreciated that the example email server 106 may operate on the SMTP platform 202, but that other platforms and/or network communication systems may be employed. The SMTP platform 202 may be used to send and receive email messages 204 between a desktop 102 and a laptop 206. It is understood by persons having skill in the art that the SMTP platform 202 employs a store and forward process, which typically requires an intermediary server or the like to store data in order to effectuate an email message 204. Moreover, the SMTP platform 202 does not provide for direct communication between devices such as desktops 102. Preferably, a complimentary protocol such as POP3 may be used in conjunction with SMTP platform 202 for receiving email messages 204. It should be appreciated that the desktop 102 and laptop 204 are merely examples, and that any type of computing device capable of utilizing the SMTP platform 202 may communicate via the email server 106. The desktop 102 may have a firewall 208 operating in conjunction with the email server 106. The firewall 208 may be associated with the desktop 102 to provide security for incoming email messages 204 via the email server 106. The email server 106 may communicate with the SMS gateway 108 using the SMTP platform 202.

The SMS gateway 108 may convert an email message 204 from the SMTP platform 202 to an SMS message 210 on an SMS platform 212. The SMS platform 212 allows a mobile device 104 to communicate directly with another mobile device 104 via the SMS platform 108 by transmitting and receiving SMS messages 210 directly from one mobile device 104 to a second mobile device 104. SMS messages 210 are commonly referred to as text messages. It may be appreciated by persons having skill in the art that direct communication between mobile devices 104, such as SMS messages, may be achieved without the store and forward process employed by the SMTP platform 202. Examples of a mobile device 104 include a smart-phone 214, a PDA 216, or a cell phone 218. It should be appreciated that other mobile devices 104 may be used with the SMS platform 212. The SMS gateway 208 converts email messages 204 to SMS messages 210 and SMS messages 210 to email messages 204.

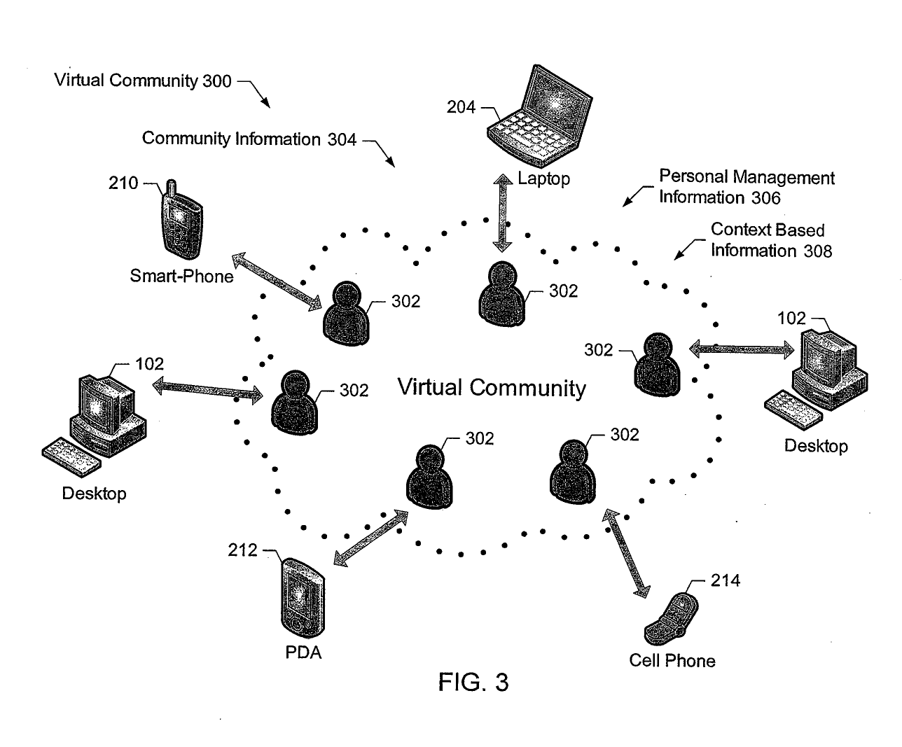

FIG. 3 is a block diagram of an example virtual community 300. The example virtual community 300 is comprised of members 302. The members 302 communicate via the network communication system 100. Examples of a virtual community 300 include a family, a sports team, a university class, an organization, a group of friends, and a company. For example, the members 302 of a company virtual community 300 may include the company president, managers, and employees. The members 302 interact with the virtual community 300 to provide and receive community information 304. Community information 304 may be comprised of two primary types of information. Personal management information 306 may be comprised of information regarding contacts, calendar appointments, tasks, notes, etc. Context based information 308 may be comprised of information regarding user name, user address, user location information, weather information related to the user location, device status such as battery level or headphone status, device information such as device capabilities, hardware details, operating system details, file details, network details, application details, etc. It should be appreciated that the example community information 304 may be comprised of personal management information 306, context based information 308, and/or some other information. Community information 304 may be categorized and/or prioritized based upon its status as personal management information 306 or context based information 308.

A member 302 may interact with the virtual community 300 by accessing community information 304 to stay informed about the virtual community 300 activities and status. A member 302 may interact with the virtual community 300 by providing personal management information 306 and context based information 308 to allow the virtual community 300 to stay informed about the member's 302 activities and status. Members 302 may interact with the virtual community 300 using any device capable of sending and/or receiving email messages 204 and/or SMS messages 210. When a member 302 provides new community information 304 to the virtual community 300, the community information 304 is synchronized so that members 302 may stay updated with the latest community information 304. The community information 304 synchronization process will be discussed in more detail below.

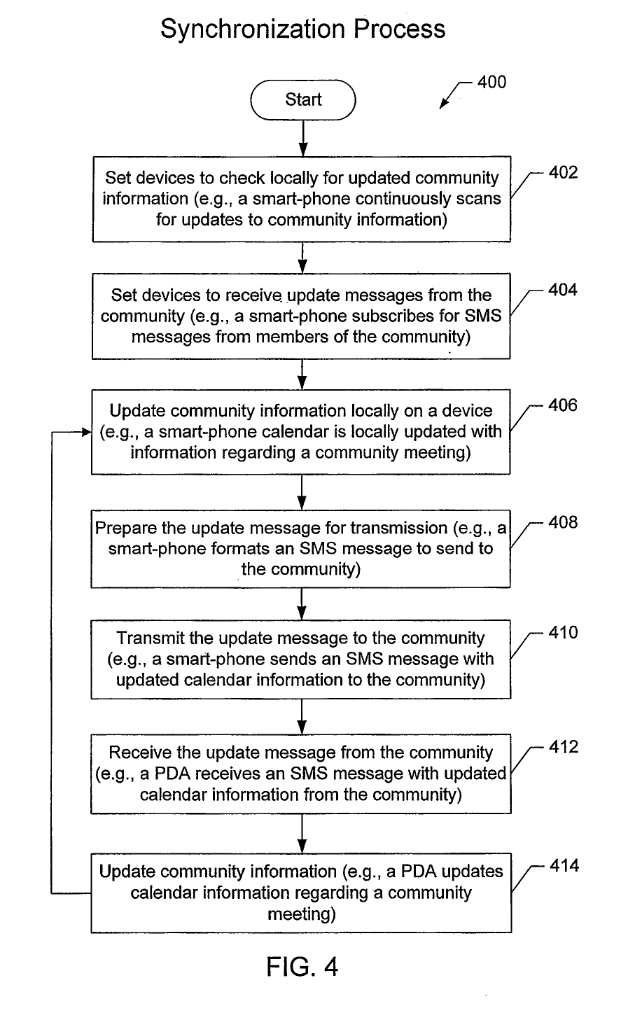

FIG. 4 is a flowchart of an example synchronization process 400 for a community. Although the synchronization process 400 is described with reference to the flowchart illustrated in FIG. 4, it will be appreciated that many other methods of performing the acts associated with synchronization process 400 may be used. For example, the order of many of the blocks may be changed, and many of the blocks described are optional.

The example synchronization process 400 begins when users set devices to check locally for updated community information 304 (block 402). For example, a member 302 sets a smart-phone 214 to continuously scan for updates to community information 304. In one embodiment, each member 302 of a virtual community 300 sets each of his devices, for example a desktop 102 and a PDA 216, to continuously scan for local updates to community information 304. For a member 302 to set the device to continuously scan for local community information 304 updates, software is preferably installed on the device to be scanned. However, the software does not need to be installed on each of a member's 302 devices. For example, a member 302 may not want a particular device to be providing and receiving updates to and from the virtual community 300. It should be appreciated that checking locally for updates may be performed in a variety of ways, including for example, receiving an update notification with the actual updated community information 304. Further, a person having skill in the art may refer to checking locally using various terms including scanning, waiting, listening, etc.

Next, set devices to receive update messages from the community (block 404). For example, a smart-phone 214 subscribes for SMS messages 210 from members 302 of the virtual community 300. In one embodiment, each member 302 of a virtual community 300 sets each of his devices, for example a desktop 102 and a PDA 216, to receive and interpret updates to community information 304 from other devices. In a preferred embodiment, software installed on the device causes the device to be ready to receive messages and recognize update messages as updates to community information 304. Messages recognized as updates to community information 304 will be interpreted and implemented as described in more detail below.

Once devices are set to check for local updates and receive updates from remote locations, the community is ready to be updated. Next, a user updates community information locally on a device (block 406). For example, a smart-phone 214 calendar is locally updated with information regarding a virtual community 300 meeting. Any change made locally on the smart-phone 214 may be an update to community information 304. Examples of changes to community information 304 include updates to the smart-phone 214 contacts list, changes in the location of the smart-phone 214, changes in the weather at the location of the smart-phone 214, the smart-phone 214 battery level falling below a threshold point, etc.

Once an update is made locally on a device, the device prepares the update message for transmission (block 408). For example, a smart-phone 214 prepares an SMS message 210 to send to the virtual community 300. The message is formatted so that the receiving devices may recognize the message as community information 304. The SMS message 210 is preferably formatted to contain information including the recipient address, the virtual community 300 associated with the message, the type of community information 304, as well as the actual update community information 304. In a preferred embodiment, the message is formatted by software installed on the device. The software may package the message in an appropriate ready-to-send format to hand off to the native device message handler for transmission.

Once the update message has been prepared for transmission, the device transmits the update message to the community (block 410). For example, a smart-phone sends an SMS message 210 with updated calendar information to the community. There are various combinations of sending and receiving messages. A smart-phone 214 may send an SMS message 210 to a PDA 216, which receives the message as an SMS message 210. A smart-phone 214 may send an SMS message 210 to a desktop 102, which receives the message as an email message 204. A desktop 102 may send an email message 204 to a laptop 206, which receives the message as an email message 204. A desktop 102 may send an email message 204 to a PDA 216, which receives the message as an SMS message 210. The community information 304 update messages are transmitted via which ever method is required or preferred by the virtual community 300 member's 302 devices. In a preferred embodiment, the update messages are sent according to the native device's standard message sending protocol. It should be appreciated that there are various techniques known to persons of skill in the art for transmitting an update message to a group of members 302. Any suitable method may be employed for message transmission to a group of members 302. Typically, the message sending technique may be provided according to software installed on the member 302 devices, utilizing the formatting style and information included with the update message.

Once an update message is transmitted to a virtual community 300, and the virtual community 300 devices are set to receive update messages, a member 302 device receives the update message from the virtual community (block 412). For example, a PDA 216 receives an SMS message 210 with updated calendar information from the virtual community 300. The member 302 device receiving the message recognizes the message as an update to community information 304. It should be appreciated that the update messages may be formatted and sent in many different ways, and the receiving devices may be set to recognize and decode the messages in many different ways. In a preferred embodiment, update messages are recognized and interpreted by software installed on the receiving device.

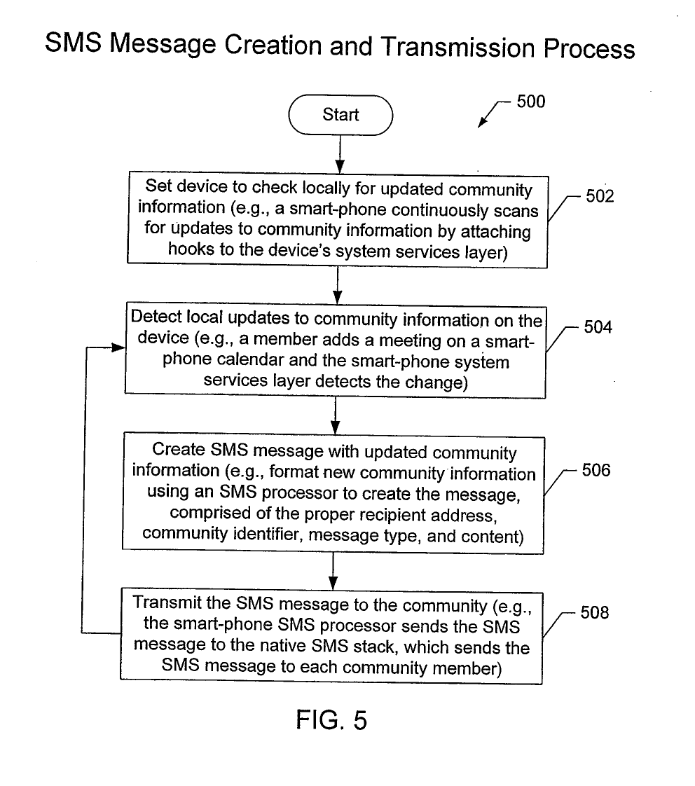

Once an update message has been received by a member 302 device, the device updates the community information 304 (block 414). For example, a PDA 216 updates calendar information regarding a community meeting. In a preferred embodiment, each device in the virtual community 300 updates the community information 304 so that the community information 304 is synchronized for all members 302. Various techniques for reducing synchronization time and/or system overhead may be employed through the method of preparing, transmitting, receiving, and updating the community information 304. It should be appreciated that the synchronization process 400 may employ various different techniques related to message types, message formation, message transmission, etc. FIGS. 5 through 8 provide more detailed examples of particular synchronization techniques. Once community information 304 is updated, devices may continue waiting for additional updates to community information (block 406).

FIG. 5 is a flowchart of an example SMS message 210 creation and transmission process 500. Although the process 500 is described with reference to the flowchart illustrated in FIG. 5, it will be appreciated that many other methods of performing the acts associated with process 500 may be used. For example, the order of many of the blocks may be changed, and many of the blocks described are optional.

The example SMS message 210 creation and transmission process 500 begins when users set devices to check locally for updated community information 304 (block 502). For example, a member 302 sets a smart-phone 214 to continuously scan for updates to community information 304 by attaching hooks to the device's system services layer. In a preferred embodiment, software is installed on a mobile device 104 that checks a variety of sources for updates to community information 304. For example, sources of information monitored by a software application may include: device sensors such as a battery sensor; native applications such as calendar, contacts, tasks; external triggers, such as a telephone call, SMS message 210, MMS message, web service request through HTTP, etc. Preferably, the software that checks for updates is installed on the device as an application in a language native to the device. Accordingly, an application service provider is not required to determine that an update to community information 304 has occurred. Programming interfaces available for use with SMS include languages such as C++, C#, and Java 2.0 Micro Edition. The software application runs in the background so the device operates normally except when an SMS message 210 is received. It should be appreciated that various languages are used with different messaging devices, and the programming language may be selected accordingly.

Once devices are set to check for updates, a device detects a local update to community information 304 on the device (block 504). For example, a member 302 adds a meeting on a smart-phone 214 calendar and the smart-phone 214 system services layer detects the change. The change is preferably recognized by a software application checking for updates by continuously scanning the device's systems services layer.

Once an update is detected, the device creates an SMS message 210 with updated community information 304 (block 506). To create an SMS message 210, the device formats the new community information 304 using an SMS processor software application to create the message, which is comprised of a header such as the recipient address, a community identifier, the message type, and the message content. As discussed previously, a message may be formatted in a variety of ways. An SMS message 210 is preferably formatted to contain information including the recipient address, the virtual community 300 associated with the message, the type of community information 304, as well as the actual update community information 304. In a preferred embodiment, the message is formatted by an SMS processor software application installed on the device. The application may package the message in an appropriate ready-to-send format to hand off to the native device message handler for transmission. For example, the SMS processor software application formats an SMS message 210 with a header, an identifier, a message type, and message information, which can be recognized as community information 304 by the receiving device. Once formatted, the message is ready to be handed off to the native device message handler for transmission.

Once a message is formatted and ready to send, the device transmits the SMS message to the community (block 508). For example, the smart-phone 214 SMS processor software application sends the SMS message 210 to the smart-phone's 214 native SMS stack, which then sends the SMS message 210 to each virtual community 300 member 302. It should be appreciated by persons having skill in the art, that a mobile device 104 typically uses a message handler such as a native SMS stack, through which all incoming and outgoing messages are staged. The native SMS stack is a basic component of a typical mobile device 104, and uses various protocols and native software applications to operate. The native SMS stack handles any SMS message 210 that has been properly formatted, so the SMS processor software application formats the outgoing SMS message 210 accordingly.

The example SMS message 210 is sent via the SMS platform 212 to another member 302 device. As FIG. 2 illustrates, in an embodiment, an SMS message 210 may be transmitted from a smart-phone 214 directly to a PDA 216 and/or a cell phone 218, or an SMS message 210 may be transmitted from a smart-phone 214 through an SMS gateway 108 to a PDA 216 and/or a cell phone 218. Further, an SMS message 210 may be transmitted from a smart-phone 214 to a desktop 102 through an SMS gateway 108 and an email server 106. An SMS message 210 recipient may be automatically recognized as an email address, in which case, an SMS gateway 108 may use the SMTP platform 202 to send the message to its final destination. It should be appreciated that while the SMS platform 212 is compatible with the SMTP platform 202, the SMS platform 212 may provide advantages over the SMTP platform 202 in some cases. For example, the SMS platform 212 may provide for immediate message delivery when available, and delayed message delivery if the recipient device is unavailable. The SMS platform 212 therefore provides advantages for synchronizing community information 304 of a virtual community 300. Once a message has been transmitted, the device may resume detecting local updates to community information 304 (block 504).

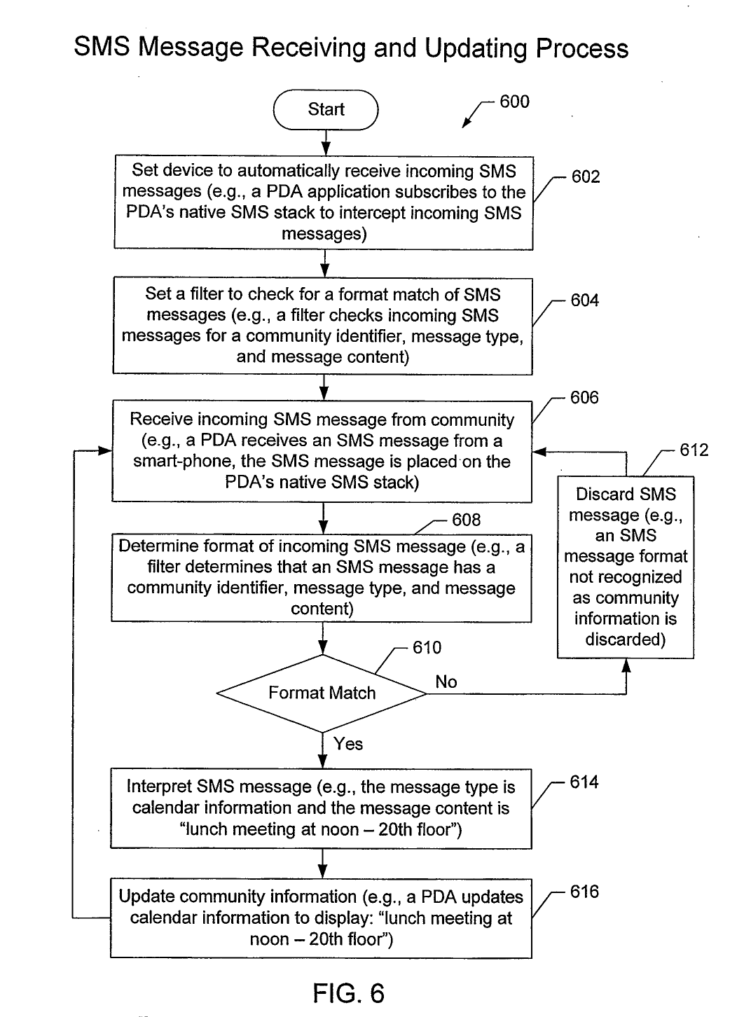

FIG. 6 is a flowchart of an example SMS message 210 receiving and updating process 600. Although the process 600 is described with reference to the flowchart illustrated in FIG. 6, it will be appreciated that many other methods of performing the acts associated with process 600 may be used. For example, the order of many of the blocks may be changed, and many of the blocks described are optional.

The example SMS message 210 receiving and updating process 600 begins when users set devices to automatically receive incoming SMS messages 210 (block 602). For example, a PDA 216 application subscribes to the PDA's 216 native SMS stack to intercept all incoming SMS messages 210. As noted previously, in a typical mobile device 104, incoming SMS messages 210 are initially placed in the native SMS stack, so in an embodiment, a software application is installed on the device to receive SMS messages 210 directly from the native SMS stack. Next, set a filter to check for a format match of SMS messages 210 (block 604). For example, a filter checks incoming SMS messages 210 for a community identifier, message type, and message content which may be set as a header in the incoming SMS messages 210. The first few tokens of incoming SMS text may represent a header. The filter will determine whether an SMS message 210 is a community information 304 update or a regular SMS message 210.

Once a device is set to receive and filter incoming SMS messages 210, the device receives an incoming SMS message 210 (block 606). For example, a PDA 216 receives an SMS message 210 from a smart-phone 214, so the SMS message 210 is placed on the PDA's 216 native SMS stack. The SMS message 210 may be received directly from a mobile device 104 or an SMS gateway 108. Next, a device determines the format of an incoming SMS message 210 (block 608). For example, a filter determines that an SMS message 210 has a pre-defined format, such as a community identifier, a message type, and message content. Once the device filters the message to determine the format of the SMS message 210, the device determines if there is a format match (block 610). If there is a format match, the SMS message 210 is a community information 304 update. If there is not a format match, the SMS message 210 is a regular SMS message 210 that is not a community information 304 update.

If a device has determined that an SMS message 210 is not a format match, the software application discards the SMS message 210 (block 612). For example, an SMS message 210 format not recognized as community information 304 is discarded and may be handled by the native SMS stack as a normal message. If the SMS message 210 is not formatted with a message type or community identifier, the message does not fit the pre-defined format and is not recognized as community information 304. Preferably, when an SMS message 210 is not a format match, the message is treated as a normal SMS message 210, and the message content is displayed normally via the native SMS stack handling the SMS message 210 normally.

If a device has determined that an SMS message 210 is a format match, the software application interprets the SMS message 210 (block 614). For example, the message type is calendar information and the message content is “lunch meeting at noon-20th floor”. The software application interpreting the SMS message 210 may use codes for community identifier and message type information. For example, calendar information may be represented by “C#” and task information may be represented by “T#”.

Once an SMS message 210 has been interpreted, the device updates community information 304 (block 616). For example, a PDA 216 updates calendar information to display: “lunch meeting at noon-20th floor”. Various features may be included in updating the community information 304. For example, a PDA 216 may provide audio and visual alerts for certain types of updates in addition to updating a particular application. Once each member 302 of the virtual community 300 utilizing the SMS platform 212 has received and interpreted an SMS message 210, the community information 304 is updated accordingly. When the update is complete, the member 302 devices are waiting to receive more incoming SMS messages 210 from the virtual community 300 (block 606). The process 600 may be repeated for each incoming SMS message 210.

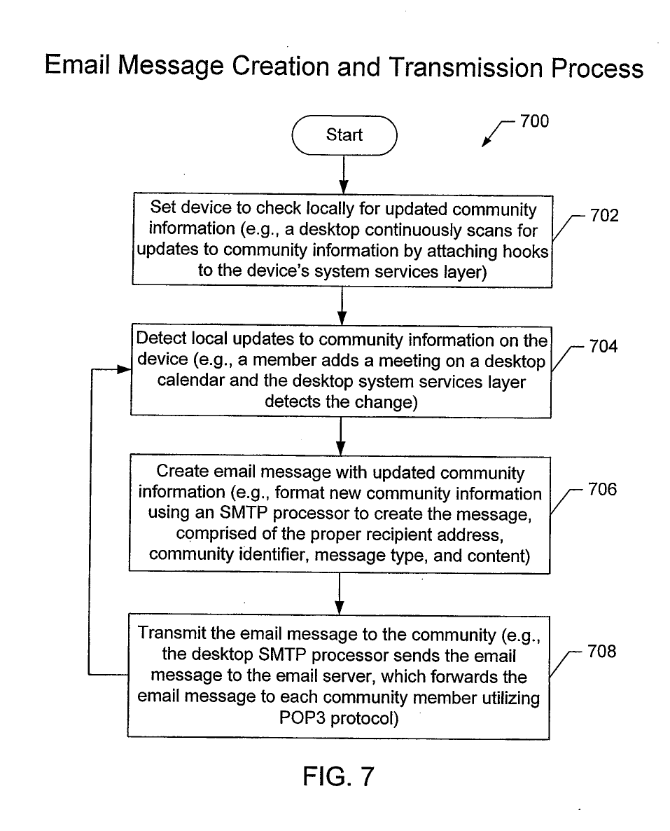

FIG. 7 is a flowchart of an example email message 204 creation and transmission process 700. Although the process 700 is described with reference to the flowchart illustrated in FIG. 7, it will be appreciated that many other methods of performing the acts associated with process 700 may be used. For example, the order of many of the blocks may be changed, and many of the blocks described are optional.

The example email message 204 creation and transmission process 700 begins when users set devices to check locally for updated community information 304 (block 702). For example, a member 302 sets a desktop 102 to continuously scan for updates to community information by attaching hooks to the device's system services layer. In a preferred embodiment, software is installed on a desktop 102 that checks a variety of sources for updates to community information 304. For example, sources of information monitored by a software application may include: native applications such as calendar, contacts, tasks; external triggers, such as an email message 204, instant message, web service request through HTTP, etc. Preferably, the software that checks for updates is installed on the device as an application in a language native to the device. Accordingly, an application service provider is not required to determine that an update to community information 304 has occurred. The software application runs in the background so the device operates normally except when an email message 204 is received. It should be appreciated that various languages are used with different email services, and the programming language may be selected accordingly.

Once devices are set to check for updates, a device detects a local update to community information 304 on the device (block 704). For example, a member 302 adds a meeting on a desktop 102 calendar and the desktop 102 system services layer detects the change. The change is preferably recognized by a software application checking for updates by continuously scanning the device's systems services layer.

Once an update is detected, the device creates an email message 204 with updated community information 304 (block 706). For example, to create an email message 204, the device formats the new community information 304 using an SMTP processor software application to create the message, which is comprised of a header such as the recipient address, a community identifier, the message type, and the message content. As discussed previously, a message may be formatted in a variety of ways. An email message 204 is preferably formatted to contain information including the recipient address, the virtual community 300 associated with the message, the type of community information 304, as well as the actual update community information 304. In a preferred embodiment, the message is formatted by a software application installed on the device. The application may package the message in an appropriate ready-to-send format to hand off to the native device message handler for transmission. For example, an SMTP processor software application formats an email message 204 with a header, an identifier, a message type, and message information, which can be recognized as community information 304 by the receiving device. Once formatted, the email message 204 is ready to be handed off to the native device message handler for transmission.

Once a message is formatted and ready to send, the device transmits the email message 204 to the virtual community 300 (block 708). For example, the desktop 102 uses desktop's 102 message handler to send the email message 204 to an email server 106, which forwards the email message 204 to each virtual community 300 member 302 preferably utilizing POP3 protocol. It should be appreciated that many different protocols may be utilized by a device message handler for sending and receiving messages. As FIG. 2 illustrates, in an embodiment, an email message 204 may be transmitted from a desktop 102 to a laptop 206 via an email server 106 using the SMTP platform 202. An email message 204 may be transmitted from a desktop 102 to a smart-phone 214 through an email server 106 and an SMS gateway 108. An email message 204 may be forwarded to an SMS address such as a telephone number, in which case, the email message 204 would typically be directed to an SMS gateway 108. An SMS gateway 108 may convert the email message 204 to an SMS message 210 to send to its final destination via the SMS platform 202. Once a message has been transmitted, the device may resume detecting local updates to community information 304 (block 704).

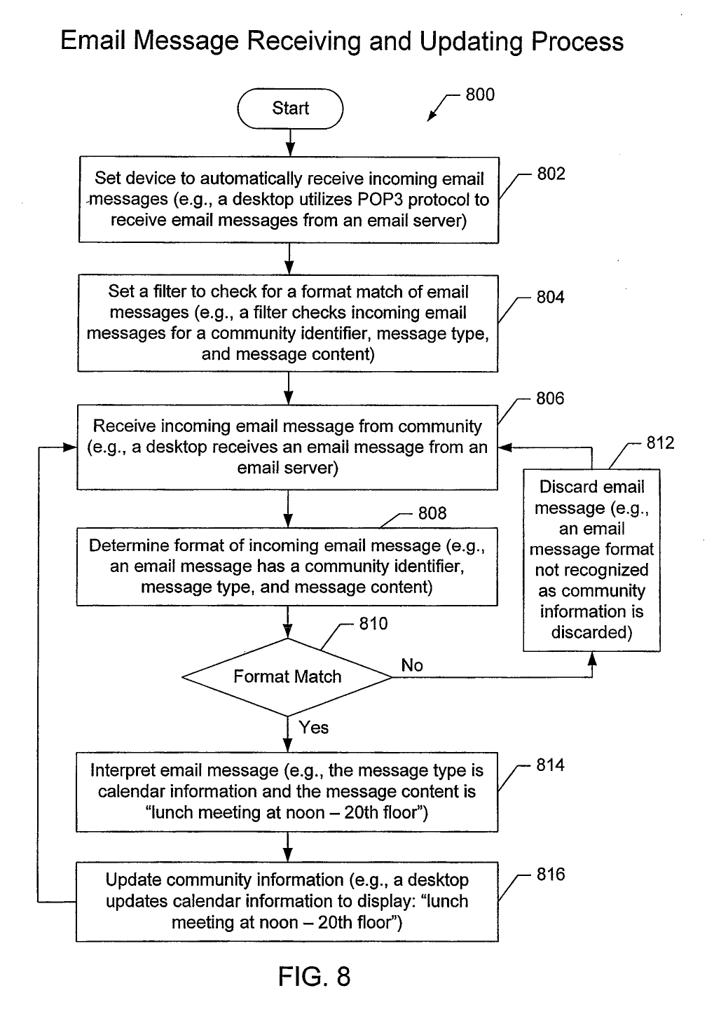

FIG. 8 is a flowchart of an example email message 204 receiving and updating process 800. Although the process 800 is described with reference to the flowchart illustrated in FIG. 8, it will be appreciated that many other methods of performing the acts associated with process 800 may be used. For example, the order of many of the blocks may be changed, and many of the blocks described are optional.

The example email message 204 receiving and updating process 800 begins when users set devices to automatically receive incoming email messages 204 (block 802). For example, a desktop 102 utilizes POP3 protocol to receive email messages 204 from an email server 106. Persons having skill in the art should appreciate that POP3 protocol is a standard protocol used to retrieve email messages 204 from an email server 106 using the SMTP platform 202. Next, set a filter to check for a format match of email messages 204 (block 804). For example, a filter checks incoming email messages 204 for a community identifier, message type, and message content. The filter will determine whether an email message 204 is a community information 304 update or a regular email message 204.

Once a device is set to receive and filter incoming email messages 204, the device receives an incoming email message 204 (block 806). For example, a desktop 102 receives an email message 204 from an email server 106. Next, a device determines the format of an incoming email message 204 (block 808). For example, a filter determines that an email message 204 has a pre-defined format, such as a community identifier, a message type, and message content. Once the device filters the message to determine the format of the email message 204, the device determines if there is a format match (block 810). If there is a format match, the email message 204 is a community information 304 update. If there is not a format match, the email message 204 is a regular email message 204 that is not a community information 304 update and may be handled in a normal way.

If a device has determined that an email message 204 is not a format match, the software application discards the email message 204 (block 812). For example, an email message 204 format not recognized as community information 304 is discarded. If the email message 204 is not formatted with a message type or community identifier, the message does not fit the pre-defined format and is not recognized as community information 304. Preferably, when an email message 204 is not a format match, the message is treated as a normal email message 204, and the message is handled normally. For example, an email message 204 that is not a format match may be forwarded to the user's email inbox.

If a device has determined that an email message 204 is a format match, the software application interprets the email message 204 (block 814). For example, the message type is calendar information and the message content is “lunch meeting at noon-20th floor”. The software application interpreting the email message 204 may use codes for community identifier and message type information. For example, calendar information may be represented by “C#” and task information may be represented by “T#”.

Once an email message 204 has been interpreted, the device updates community information 304 (block 816). For example, a desktop 102 updates calendar information to display: “lunch meeting at noon-20th floor”. Various features may be included in updating the community information 304. For example, a desktop 102 may provide audio and visual alerts for certain types of updates in addition to updating a particular application. Once each member 302 of the virtual community 300 utilizing the SMTP platform 202 has received and interpreted an email message 204, the community information 304 is updated accordingly. When the update is complete, the member 302 devices are waiting to receive more incoming email messages 204 from the virtual community 300 (block 806). The process 800 may be repeated for each incoming email message 204.

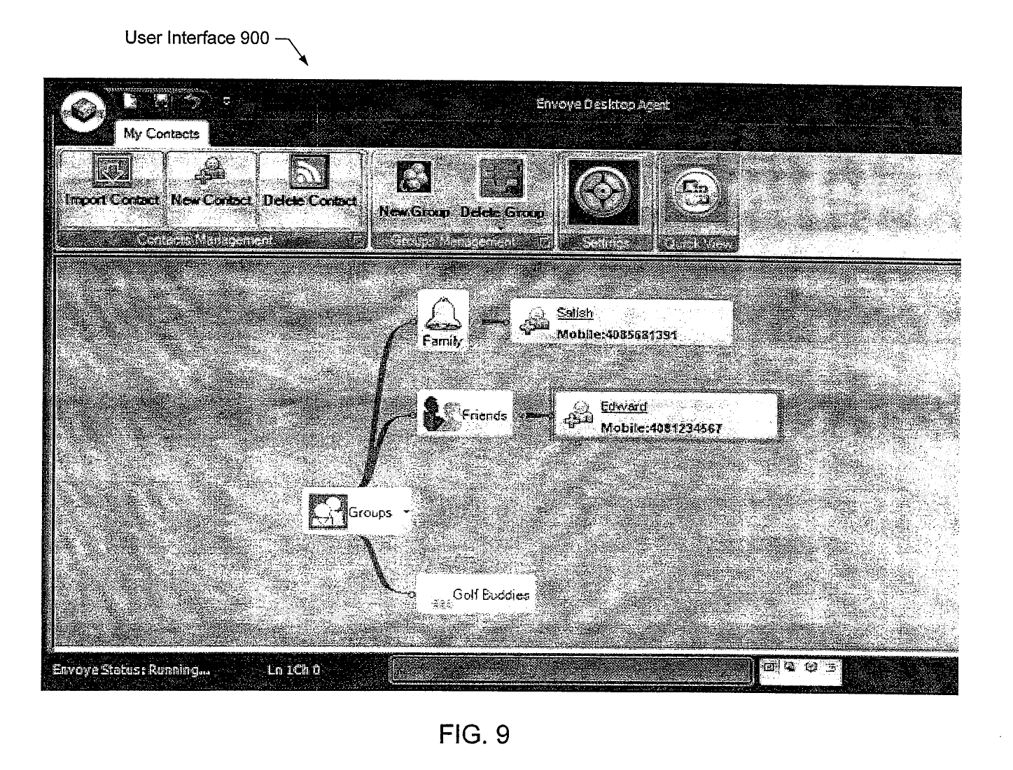

It should be appreciated that the synchronization process 400 may be associated with various user interfaces for displaying and receiving community information 304. FIG. 9 is an example screenshot showing a user interface 900 for managing groups and contacts. A user's contacts may be categorized into groups. The user may set policies regarding which groups are included within a virtual community 300. For example, a user may have groups including family, friends, and golf buddies. Each group may be a separate virtual community 300, however, sub-groups may exist and groups may overlap as selected by the user. The user may wish to update a virtual community's 300 calendar information with the location and tee time of the next golf outing. A policy may be set to only transmit this information within the golf buddies group, so the family and friends groups do not receive unnecessary community information 304 updates. It should be appreciated that various types of policies may be set to selectively provide or receive particular community information 304.

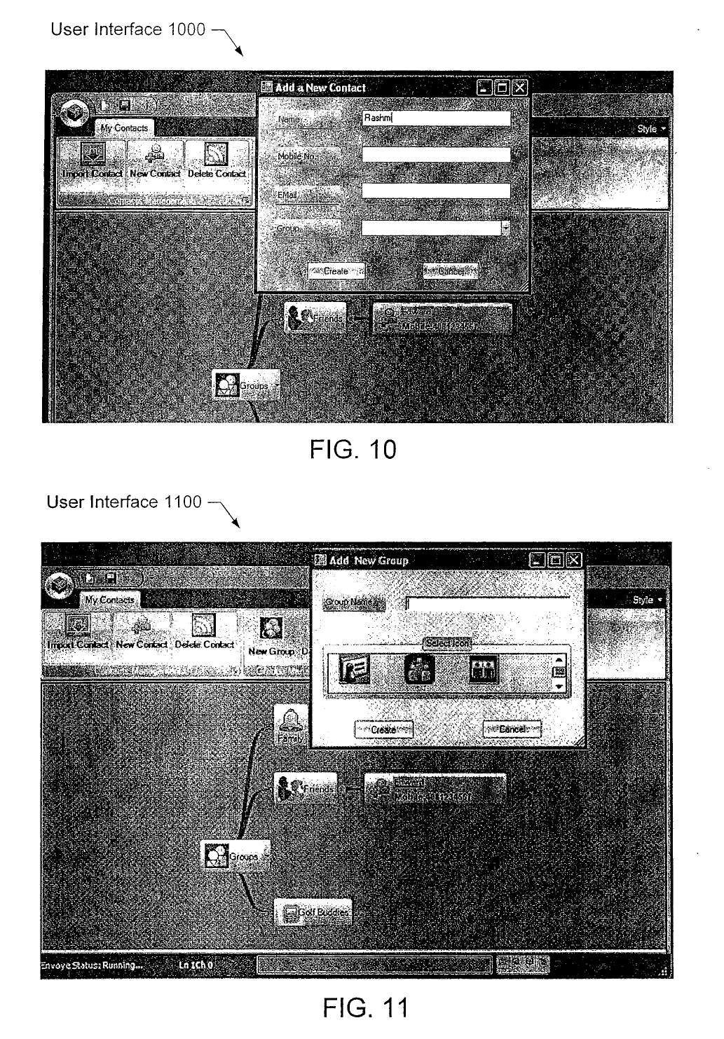

FIG. 10 is an example screenshot showing a user interface 1000 for managing contacts. Contact information may be entered into the user interface 1000. The example screenshot shows a user creating a new contact. The example user interface 1000 may allow for various contact information to be maintained including: name, email address, mobile device number, address, location, relationship, type of device in use, location, weather, current mood, current music being listened to, type of access such as private, public, protected, etc., picture, icon, blog URL, notes, description, company, groups, work phone number, home phone number, preferred connection type such as SMS, email, phone, MMS, etc. In a preferred embodiment, various operations relating to contact information may be performed via the example user interface 1000, such as: create a new contact, edit an existing contact, and delete an existing contact.

FIG. 11 is an example screenshot showing a user interface 1100 for managing groups. Group information may be entered into the user interface 1100. The example screenshot shows a user creating a new group. The example user interface 1100 may allow for various group information to be maintained including: group name, group type, description, type of members 302, number of members 302, picture, icon, group web site URL, location, etc. In a preferred embodiment, various operations relating to group information may be performed via the example user interface 1100, such as: create a new group, edit an existing group, and delete an existing group.

It should be appreciated that the synchronization process 400 is complimented by the use of policies applied to groups and/or contacts. Various policy types may be employed via the example user interface 900. Policies may be preset or dynamic depending on the function desired. For example, a message may be sent to contacts or groups based on a policy such as a date and time trigger, date and time range trigger, area code, email domain, location, current mood, weather, etc. A user may want to send a message such as “Free Beer Tonight at The Pub!!!”, only to members 302 who have their current mood set to “partying” and are in a specific range of the user's location, and/or may wish to exclude groups such as “Grandmother's Knitting Club”. It should be appreciated that policies may be used not only to sending messages, but also to receiving messages. For example, while a user is at work, the user may only want to receive updated community information 304 from a “Work” group, so the user is not interrupted by non-work related updates. Policies may also be applied to community information 304 updates based on the type of community information 304 being shared. For example, personal management information 306 may be differentiated from context based information 308. In an embodiment, updates to personal management information 306 may provide alerts, while updates to context based information 308 may not provide alerts.

A virtual community's 300 data may be integrated with third party personal management information 306 and context based information 308 servers. For example, messages may be formatted in XML format and transmitted to an external system using an email message or a media utilizing HTTP. Further, the community information 304 may be transmitted to a data server for backup purposes. It should be appreciated by persons having skill in the art that various methods for integrating or backing up community information data may be employed. For example, using XML protocol, community information 304 data may be published as a service that is subscribed to by various external systems. Additionally, a virtual community 300 may import data from an external service such as a web-service. In an embodiment, a virtual community 300 may import metadata from external systems, such as a contacts list, calendar information, task list, etc. from a system such as Yahoo®, Google™, etc. It should be appreciated that various systems may import data which may by synchronized within the virtual community 300.

It should be appreciated that in an embodiment, an advertisement providing system is integrated with the example synchronization process 400. The advertising providing system may exchange advertisement data with an example user interface 900. It should be appreciated by persons having skill in the art that an advertisement system may be utilized in a variety of ways in association with a synchronization process 400 and/or a virtual community 300. Further, it should be appreciated that an advertisement system may be employed in a variety of manners.

In summary, persons of ordinary skill in the art will readily appreciate that methods and apparatus for synchronizing information using SMS and email services have been described. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method for synchronizing information within a plurality of user devices, the plurality of user devices including at least one mobile user device structured to use a short message service to communicate with the plurality of user devices, the method comprising:
setting each user device in the plurality of user devices to check locally for updated information, each user device having a user interface device local to the user device for entering updated information, wherein the check for updated information is performed by an application local to each user device;
setting each user device in the plurality of user devices to receive messages including the updated information from other user devices in the plurality of user devices;
updating information locally at a first user device of the plurality of user devices;
determining that information has been updated locally using the application local to the first user device;
preparing a message at the first user device, the message including the updated information;
transmitting the message from the first user device to a second user device;
receiving the message at the second user device of the plurality of devices; and
updating the second user device based on the updated information.

2. The method of claim 1, wherein the first user device communicates via a different communication platform than the second user device.

3. The method of claim 2, wherein the first user device communication platform is the short message service.

4. The method of claim 2, wherein the first user device communication platform is an email service.

5. The method of claim 1, wherein the updated information is personal management information.

6. The method of claim 5, wherein the personal management information includes at least one of contact information, calendar appointment information, task information, and notes information.

7. The method of claim 1, wherein the updated information is context based information.

8. The method of claim 7, wherein the context based information includes at least one of name information, location information, weather information, status information, device information, and network information.

9. The method of claim 1, wherein the first user device transmits the message according to a policy.

10. The method of claim 9, wherein a user of the first user device sets the policy via a user interface.

11. The method of claim 9, wherein the policy selects a date and a time to transmit a message.

12. The method of claim 9, wherein the first user device transmits the message to selected user devices according to the policy.

13. The method of claim 12, wherein the policy selects user devices based upon at least one of personal management information and context based information.

14. A user device for synchronizing information, the apparatus comprising:
a processor;
a network device operatively coupled to the processor, the network device communicating with a plurality of network devices, the plurality of network devices including at least one mobile network device using a short message service to communicate with the plurality of network devices; and
a user interface device operatively coupled to the processor, the processor executing a software program to cause the processor to:
display information on the user interface device;
check locally for updated information using a local application;
accept information updates indicative of updated information, the information updates being entered by at least one of a user via the user interface device and the plurality of network devices;
detect a first information update entered via the user interface device;
prepare a first message indicative of the first information update;
transmit the first message via the network device to at least one of the network devices in the plurality of network devices;
receive a second message via the network device from at least one of the network devices in the plurality of network devices, the second message being indicative of a second information update, wherein the second information update originates from a second user device associated with at least one of the network devices in the plurality of network devices; and
update the user interface device to display the second information update.

15. The user device of claim 14, wherein the first information update includes personal management information.

16. The user device of claim 14, wherein the first information update includes context based information.

17. The user device of claim 14, wherein the first message is transmitted according to a policy.
